(19) United States
(12) Patent Application Publication
(10) Pub. No.: US 2022/0295767 A1
(43) Pub. Date: Sep. 22, 2022

(54) TRAWL DOOR WITH LIFT ADJUSTING MEANS

(71) Applicant: MLD APS, Esbjerg (DK)

(72) Inventors: Gregers BAUNGAARD, Esbjerg (DK); Thyge BAUNGAARD, Esbjerg (DK)

(73) Assignee: MLD APS, Esbjerg (DK)

(21) Appl. No.: 17/619,030

(22) PCT Filed: May 29, 2020
(86) PCT No.: PCT/IB2020/055115

§ 371 Date: Dec. 14, 2021

(30) Foreign Application Priority Data
Jun. 18, 2019 (DK) PA 2019 00736

(51) Int. Cl. A01K 73/045

(52) U.S. Cl. CPC A01K 73/045

(57) ABSTRACT

A trawl door used for trawl fishing, and more particularly, a trawl door adapted for stable and efficient operation. The door is equipped with moveable plate members (44) mounted on an outer panel (18) of the trawl door, hereby controlling an opening (42) in the outer panel and as a result controlling the lift of the trawl door.

### TECHNICAL FIELD

The present invention relates to trawl doors or so-called “otter-boards” in general, and especially to remotely adjustable trawl doors with adjustable lift, adapted for stable and efficient operation.

### BACKGROUND OF THE INVENTION

The purpose of trawl doors is to steer the trawl under water and to adjust the lift (horizontal spread) of the trawl net. Preferably, two trawl doors are attached to a trailing boat by means of wires or chains, and from each trawl door wires extend to each side of the trawl net.

Typically, trawl doors act as wings, using a hydrodynamic shape, such as an hydrofoil construction, to provide horizontal lift (spread). As with all wings, the towing vessel must go at a certain speed in order for the doors to remain standing and functional. This speed varies, but is generally in the range of 2.5-5.0 knots

The position of each trawl door in the water is controlled by adjusting the fastening points in the wires between the trawl door and the boat. This adjustment is carried out on the boat, and the trawl door therefore has to be lifted out of the water before the adjustment. Such adjustment is time consuming and costly in work labour and dangerous for the worker, and therefore there is a need for a more flexible and economic solution.

Modern trawl fishing is complicated by an increase in operating costs due primarily to increasing transportation and fuel costs. The increase in operating costs, in combination with the tendency of regulatory authorities to impose fixed catch quotas in one form or another, have combined forced trawl fishing vessel operators to increase the efficiency of their trawl systems. One impact of this demand for increased efficiency of the trawl system is a demand for increased trawl door efficiency, and in particular an ever increasing need for trawl doors that are efficient at shallow depths and high speeds, as modern trawling increasingly requires economic operations at shallow depths and high speeds.

In addition, more and more modern trawling vessels must participate in a variety of different fisheries in order to be economical, and thus must use a variety of different trawls, having different requirements for the opening parameters of their trawl mouths. For example, some fisheries require trawls exhibiting a high vertical opening and a moderate horizontal opening (high opening trawls), meaning that the trawl doors should provide less lift (spread) and thus generate less water resistance, while other fisheries require trawls exhibiting a low vertical opening and a maximal horizontal opening (wide body trawls), meaning that maximal lift (spreading) forces are needed from the trawl doors.

While a towed trawl door having a particular shape may operate stably throughout a range of angle of attack when towed through water at a larger angle of attack, trawl doors often exhibit instability and/or low efficiency. Moreover, how the towing vessel manoeuvres can vary a trawl door's angle of attack.

Trawl doors operating at large angles of attack create enough drag-induced directional forces on the trawl doors in order to impart sufficient stability to the trawl door system and thereby to maintain the trawl doors in a workable orientation in the presence of a multitude of destabilizing forces routinely imparted to a trawl door during use.

Destabilizing forces result from, for example, side currents, imperfections in rigging, and loss of forward through-water speed, affecting an inboard trawl door during turning of a trawling vessel. For example, when a towing vessel turns the inboard trawl door, it may become almost stationary relative to the water. A similar situation can arise when a trawl door experiences a strong side current. Another condition which can cause trawl door instability is when a portion of the trawl contacts the sea floor. As is readily apparent, a trawl contacting the sea floor increases the force applied to the trawl door through the lower towing bridle in comparison with the force applied through the upper towing bridle. Stabilizing trawl doors when they operate under conditions such as those described above usually requires that the trawl doors operate at a larger angle of attack, particularly at slower towing speeds.

Higher angles of attack are required at slower towing speeds to obtain a sufficiently large drag-induced force vector required to stabilize trawl doors at slower towing speeds. Furthermore, when trawl doors lose their ability to spread, they may tangle with each other.

WO 2015055207 discloses a trawl door comprising an upper frame, a lower frame, and an intermediate frame. The trawl door has several foils or panels and discloses a moveable plate arranged at a trailing edge of a body plate, which is the largest of the foil and the one arranged on the inner trawl door side surface, which is the surface facing the trawl mouth and the trawl door arranged on the opposite side of the trawl. WO 2015055207 does not disclose flaps provided on outer panels which face toward the outer side surface of the trawl door.

There exists a long-felt need for a trawl door that is highly efficient at larger angles of attack and thus can be used at slower towing speeds, while not being markedly larger in size than existing trawl doors.

Furthermore, there exists a desire in the industry for a highly efficient trawl door that operates well both at faster towing speeds and smaller angles of attack as well as at slower towing speeds and larger angles of attack. Therefore, there exists a need for arranging a trawl door where the lift of the trawl door can be adjusted efficiently and in real-time during fishing, and without lifting the trawl doors out of the water.

The above object and advantages together with numerous other objects and advantages, which will be evident from the description of the present invention, are according to an aspect of the present invention obtained by:

A trawl door with lift adjusting means adapted to being remotely controlled, the trawl door comprising:
an upper frame defining a top surface of the trawl door,
a lower frame defining a bottom surface of the trawl door, and
an intermediate frame positioned between the upper frame and the lower frame,

the trawl door further comprising:
a first number of longitudinal upper panels of hydrofoil construction arranged and extending between the upper frame and the intermediate frame, and
a second number of longitudinal lower panels of hydrofoil construction arranged and extending between the intermediate frame and the lower frame,

the trawl door having a cambered cross section and comprising a leading edge and a trailing edge, an inner trawl door side surface for facing a trawl mouth, and an opposite outer trawl door side surface,

the upper frame, the intermediate frame and the first number of upper panels defining an upper part of the trawl door, and

the intermediate frame, the bottom frame and the second number of lower panels defining a lower part of the trawl door,

the first and second number of panels each including an inner panel, which defines at least part of the inner trawl door side surface, and an outer panel, which defines at least part of the outer trawl door side surface,

the outer panels having an opening and a moveable plate member being connected to a driving unit and adapted to be controlled remotely when the trawl door is being towed through the water, such that the moveable member may be arranged in a first position closing the opening, and in a second position establishing an adjustable opening through the outer panel side surfaces, hereby adjusting a flow of water through the outer panels.

Tests performed by the applicant have shown that by arranging one or both outer panels of the trawl door with a controlled opening as defined above, and in a situation where the moveable plate member is not blocking the opening through the outer panel, the lift of the trawl door can be adjusted stepless, enabling control of the lift from the trawl doors maximum performance to almost zero whereby the lift is almost completely eliminated.

Hereby, the lift of the individual trawl doors may be controlled more precisely, resulting in a more controlled spread of the trawl mouth. This technical effect is achieved due to the huge pressure difference between the inner side of the outer panel and the outer side of the outer panel. On the inner side there exists a large pressure as a result of the hydrofoil shape and the trawl door being dragged through the water, and on the outer side of the panel there is established a suction/vacuum which generates the lift of the trawl door.

Arranging an opening through the outer panel has the surprising technical effect that the lift can be adjusted down to almost zero.

According to a further embodiment of the first aspect of the present invention, the moveable plate member comprises a flap being hingedly connected to the opening for moving the flap between a first open, and a second closed position.

The moveable plate member is preferably hinged to an edge part of the opening through the outer panel. Alternatively, the hinge connection may be arranged close to the opening on the outer or inner side surface of the panel.

According to a further embodiment of the first aspect of the present invention, the flap is hingedly connected to the opening through an axis substantially through a centerline of the flap.

In an alternative embodiment. The flap may be rotationally connected to the opening on an axis extending substantially through a centerline of the flap, such that that flap may rotate 360 degrees.

According to a further embodiment of the first aspect of the invention, the moveable plate member comprises a slidable plate connected to the opening in a slideable manner between a first open position and a second closed position.

The moveable plate member is preferably arranged in guides or tracks embedded or mounted on the outer panel.

According to a further embodiment of the first aspect of the invention, the flap is hingedly connected to the outer panels for pivoting about an axis, which extends parallel to the outer panels, the flap being pivotally towards the outer side surface and/or towards the inner panels.

According to a further embodiment of the first aspect of the invention, the flap is hingedly connected for opening towards the leading edge or towards the trailing edge.

Arranging the flap to be pivoted towards the outer side and/or the inner side, as well as pivoting for opening towards the leading edge or the trailing edge, enhances the possibilities of adjusting the flow of water through the opening and thus enhances the possibilities of precisely adjusting a specific, desired lift of the trawl door.

According to a further embodiment of the first aspect of the invention, the slideable plate is slideable connected to the outer panel on an outer side of the panel or an inner side of the panel.

According to a further embodiment of the first aspect, the slideable plate is slideable towards both the leading edge and the trailing edge.

Arranging the slideable plate such that it is slideable towards both the leading edge and the trailing edge provides an alternative compared to the pivotally mounted flap. In relation to the sliding plate, it is possible to achieve a situation where the opening is fully open or only partly open where the slideable plate is only slid by a smaller distance. Here it is possible to arrange a limited opening, where this limited opening is situated at the opening edge towards the leading edge and at the opening edge towards the trailing edge, which again influences the lift of the trawl door.

According to a further embodiment of the first aspect, the trawl door further comprises at least one intermediate panel extending in spaced relationship between the inner and outer panel.

Configured as defined above, the trawl door is improved in comparison with a conventional trawl door. Especially the trawl door of the present invention improves stability when the trawl door is towed through water. Further, it produces less door drag, and arranges a trawl door where the lift may be almost completely eliminated, resulting in a more precisely controlled trawl door.

The invention will now be explained in more detail below by means of examples of embodiments with reference to the very schematic drawing, in which:

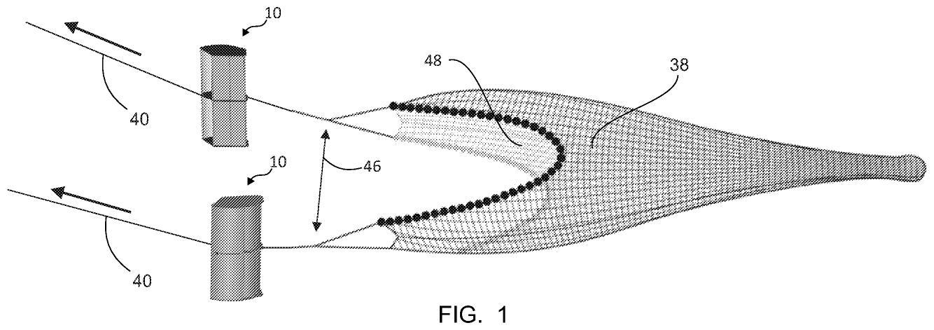

FIG. 1 shows a perspective view of a trawl system.

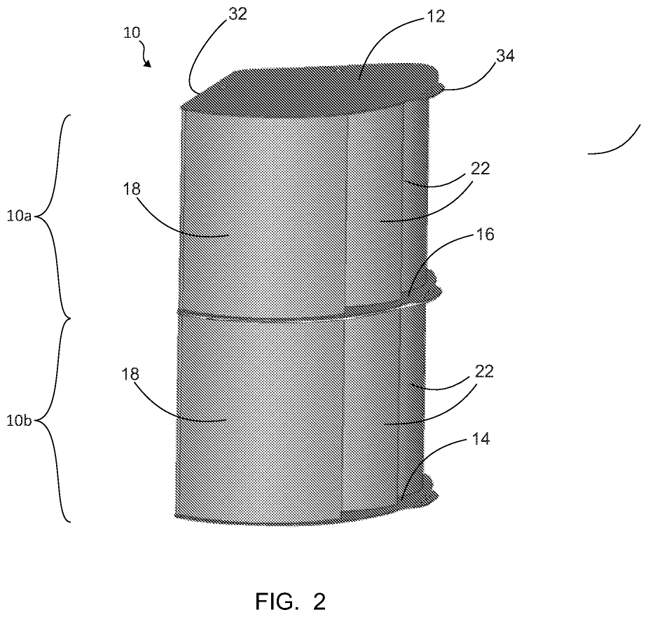

FIG. 2 shows a perspective view of a prior art trawl door.

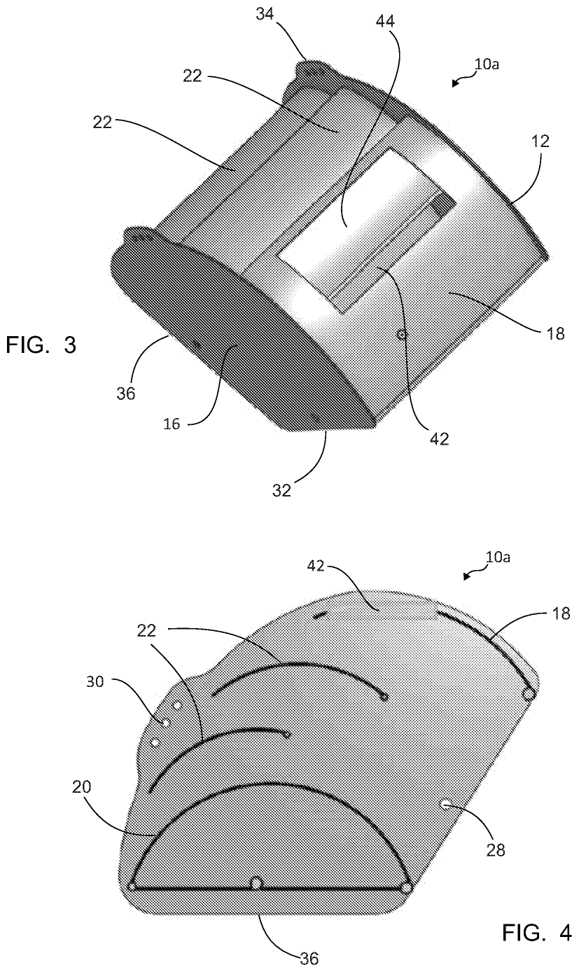

FIG. 3 shows a perspective view of an outer side of a trawl door section.

FIG. 4 shows a sectional view of a trawl door.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will, thus, not be described in detail with respect to the description of each figure.

FIG. 1 illustrates the basic arrangement of a prior art trawl system. The system comprises a trawl net 38, which comprises a trawl mouth 48 facing the trawling direction.

The trawling trawl net 38 comprises towing warps 40 being connected to either side of the trawl mouth 48 and extending from the trawl net 38 to a sailing vessel, which is indicated by the arrows. In connection with the warps 40, there is arranged a pair of trawl doors 10, each trawl door being connected to the warps 40 at either side of the trawl mouth 48, such that the trawl doors 10 arrange the trawl mouth 48 with a desired opening (spread 46). Arranging the trawl doors with increasing lift, increases the spread 46, and arranging the trawl doors with a lower lift, decreases the spread 46.

FIG. 2 illustrates a perspective view of a prior art trawl door which corresponds substantially to the applicant's prior trawl door, which is described in DK178860B1.

The trawl door 10 comprises an upper trawl door section 10a and a lower trawl door section 10b. The trawl door comprises an upper frame 12, a lower frame 14, and an intermediate frame 16, which divides the trawl door 10 in two sections. Between the upper frame 12 and the intermediate frame 16, and the intermediate frame 16 and the lower frame 14, is arranged a number of longitudinal panels of hydrofoil construction, which generates the lift of the trawl door. The trawl door comprises a leading edge 32, which during fishing faces towards the sailing vessel, and a trailing edge 34, which during fishing faces towards the trawl net 38. The longitudinal panels of hydrofoil construction comprise outer panels 18 which face towards an outside of the trawl system and away from the trawl mouth, and an inner panel (not shown) which is arranged on an opposite side of the trawl door and facing the trawl mouth 48 and the trawl door arranged on the opposite side of the trawl net 38. The outer panels 18 and the inner panels 20 are spaced in parallel relationship, and a number of intermediate panels 22 is arranged in parallel relationship in-between the outer panels 18 and inner panels 20. In the example shown in FIG. 2, the trawl door 10 comprises two intermediate panels in each of the upper panel section 10a and the lower panel section 10b, respectively. The skilled person would however recognize the possibility of arranging no intermediate panels, only one intermediate panel 22, or a number of intermediate panels 22 larger than two, e.g. three or four, etc.

FIG. 3 illustrates an embodiment according to the invention and illustrates for the purpose of simplicity only the upper trawl door section. It is however evident that the description of the drawing applies to the lower trawl door section 10b.

The upper trawl door section 10a comprises the upper frame 12, the intermediate frame 16, the outer panel 18, the inner panel 20, and the intermediate panel. It is evident from the figure that the upper panel 18 is arranged towards the leading edge 32 and the intermediate panels 22, and the inner panel 22 (not shown) are arranged towards the trailing edge 34. The outer panel 18 comprises an opening 42 and a moveable plate member 44 which in the illustrated embodiment is illustrated as a slideable plate which is moved towards the trailing edge 34, such that the upper panel 18 comprises the opening. The plate member 44 is activated by an activation mechanism, such as a mechanical, pneumatic, hydraulic or electric drive which is known to the person skilled in the art. The moveable plate member 44 may be moved back towards the leading edge 32, whereby the opening 42 is closed and the outer panel 18 comprises a complete surface. As previously described, the moveable plate member 44 may be arranged as a hinged flap generating an opening towards the leading edge or the trailing edge. The hinged flap is arranged for pivoting towards the outer side or the outer panel 18 or may in a further embodiment be arranged for pivoting in both directions.

Further, as illustrated, the moveable plate member 44 is slit towards the trailing edge, but may in a further embodiment be arranged for sliding towards the leading edge, or may even be arranged for sliding in both directions, hereby being suitable for establishing an opening 42 on either side of the plate member 44. The opening 42 and the moveable plate member 44 are illustrated with equal distance to the upper frame 12 and the intermediate frame 16; however, in another embodiment, the opening 42 and moveable plate member may be arranged either closer to the upper frame 12 or closer to the intermediate frame, whereby it is possible to influence the stability of the trawl doors when they operate under various conditions.

FIG. 4 illustrates a sectional view of the upper trawl door section 10. In the figure it is clearly illustrated that the trawl door 10 comprises first pulling points 28 for connection of the towing warp 40 between the trawl door 10 and the vessel, and second pulling points 30 for connecting the towing warp 40 between the trawl door and the trawl net 38). The arrangement of the plates 18, 22, 20 of hydrofoil construction is also evident from the figure.

Contrary to the upper panel 18 and the intermediate panels 22, the lover panel is arranged as a hollow and may as disclosed in the applicant's above mentioned patent be arranged with a moveable flap which is connected to a driving unit for controlling the opening and closing of the flap, hereby controlling the lift of the trawl door. In FIG. 4, the opening in the outer panel is illustrated with a “square”, which is arranged at a rear most part of the outer panel. Test performed by the applicant show that the opening may also be arranged in the middle of the panel or towards the trailing edge.

In the following is given a list of reference signs that are used in the detailed description of the invention and the drawings referred to in the detailed description of the invention.
10 Trawl door
10a Upper trawl door section
10b Lower trawl door section
12 Upper frame
14 Lower frame
16 Intermediate frame
18 Outer panel
20 Inner panel
22 Intermediate panel
28 First pulling points
30 Second pulling points
32 Leading edge
34 Trailing edge
36 Inner trawl door side surface
38 Trawl net
40 40 Towing warp
42 Opening
44 Moveable plate member
46 Spread
48 Trawl mouth

1. A trawl door with lift adjusting means adapted to being remotely controlled, said trawl door comprising:
an upper frame defining a top surface of the trawl door,
a lower frame defining a bottom surface of the trawl door, and
an intermediate frame positioned between said upper frame and said lower frame,
said trawl door further comprising:
a first number of longitudinal upper panels of hydrofoil construction arranged and extending between said upper frame and said intermediate frame, and
a second number of longitudinal lower panels of hydrofoil construction arranged and extending between said intermediate frame and said lower frame,
said trawl door having a cambered cross section and comprising a leading edge and a trailing edge, an inner trawl door side surface for facing a trawl mouth, and an opposite outer trawl door side surface,
said upper frame, said intermediate frame and said first number of upper panels defining an upper trawl door section of said trawl door, and
said intermediate frame, said lower frame and said second number of lower panels defining a lower trawl door section of said trawl door,
said first and second number of panels each including an inner panel, which defines at least part of said inner trawl door side surface, and an outer panel, which defines at least part of said outer trawl door side surface, wherein
said outer panels having an opening and a moveable plate member being connected to a driving unit and adapted to be controlled remotely when the trawl door is being towed through the water, such that said moveable member may be arranged in a first position closing said opening, and in a second position establishing an adjustable opening through said outer panel side surfaces, hereby adjusting a flow of water through said outer panels.

2. The trawl door according to claim 1, wherein said moveable plate member comprises a flap, hingedly connected to said opening for moving said flap between a first open and a second closed position.

3. The trawl door according to claim 1, wherein said moveable plate member comprises a slideable plate connected to said opening in a slideable manner between a first open position and a second closed position.

4. The trawl door according to claim 2, wherein said flap is hingedly connected to said outer panels for pivoting about an axis which extends parallel to said outer panels, said flap being pivotal towards said outer side surface and/or towards said inner panels.

5. The trawl door according to claim 4, wherein said flap is hingedly connected for opening towards said leading edge or towards said trailing edge.

6. The trawl door according to claim 2, wherein said flap is hingedly connected to said opening through an axis substantially through a centerline of said flap.

7. The trawl door according to claim 3, wherein said slideable plate is slideable connected to said outer panel on an outer side of said panel or an inner side of said panel.

8. The trawl door according to claim 7, wherein said slideable plate is slideable towards both said leading edge and said trailing edge.

9. The trawl door according to claim 1, wherein said trawl door further comprises at least one intermediate panel extending in spaced relationship between said inner and outer panel.
